(19) United States
(12) Patent Application Publication
(10) Pub. No.: US 2024/0002102 A1
(43) Pub. Date: Jan. 4, 2024

(54) REVERSIBLE CASK LID AND CASK ASSEMBLY SYSTEM

(71) Applicant: Blue Spruce Crafts, Christiana, PA (US)

(72) Inventor: Sylvan Stoltzfus, Christiana, PA (US)

(73) Assignee: Blue Spruce Crafts, Christiana, PA (US)

(21) Appl. No.: 17/856,491

(22) Filed: Jul. 1, 2022

(51) Int. Cl. B65D 8/00; B65D 6/00; B65D 51/24; B65D 21/02

(52) U.S. Cl. CPC B65D 9/04; B65D 9/32; B65D 51/242; B65D 21/0219

(57) ABSTRACT

A cask lid and cask assembly system are provided. The cask lid includes a first cast lid plate and a second cask lid plate to allow for stack-ability of multiple casks. The cask assembly system includes a mount base, a pivot device, and an insertion board to allow for efficient production of multiple casks. A bottom disk, a center ring and a top ring of a cask are inserted into the cask assembly system where a plurality of staves are fixed. A pivot device of the cask assembly system enables the cask to rotate while fixing the staves. The cask lid is placed over the opening of the cask and is reversible to allow for multiple casks to be stacked.

### FIELD OF INVENTION

The invention relates to a cask lid apparatus and a cask assembly system and more particularly, to a firmly sealable reversible cask lid and a pivotable cask assembly system.

### BACKGROUND

Over the years, the technology of cask lids has evolved. Reversible cask lids in the industry have grown and variations have arisen. However, the design of the cask lid has required the lid to be sealed whether by a fastener or a cask band. Therefore, there is a need for a cask lid that requires the user minimal effort to reverse the lid and allow for stack-ability of multiple casks. Moreover, the technology of cask assembly systems has evolved. The cask assembly systems of today are mainly composed of large machinery which are bulky and difficult to transport. Therefore, there is a need for a cask assembly system that can be transported easily and require minimal parts.

### SUMMARY

Accordingly, a cask lid and cask assembly system are provided. The reversible cask lid as provided includes a first cast lid plate and a second cask lid plate to allow for stack-ability of multiple casks. The cask assembly system includes a mount base, a pivot device, and an insertion board to allow for efficient production of multiple casks. A bottom disk, a center ring and a top ring of a cask are inserted into the cask assembly system where a plurality of staves are fixed. A pivot device of the cask assembly system enables a user to rotate the cask while fixing the staves to the bottom disk, the center ring and the top ring. The lid is placed over the opening of the cask and the lid may be reversed to enable stacking of multiple casks.

### BRIEF DESCRIPTION OF DRAWINGS

The invention will now be described by way of example with reference to the accompanying Figures of which:

FIG. 1 is a front, top, left exploded view of the cask assembly system;

FIG. 2 is a front, top, left perspective view of the invention of FIG. 1;

FIG. 3 is an enlarged rear, right perspective view of the invention of FIG. 2;

FIG. 4 is a front, left alternate view of the invention of FIG. 3;

FIG. 5 is a front, left perspective view of a cask in the invention of FIG. 4;

FIG. 6 is a front, top, left alternate view of the cask in the invention of FIG. 5;

FIG. 7 is a front, top, left perspective view of the cask in the invention of FIG. 6;

FIG. 8 is a front, left perspective view of the invention of FIG. 7;

FIG. 9 is a front, left perspective view of the invention of FIG. 8;

FIG. 10 is a front, top, left perspective view of the cask of FIG. 9;

FIG. 11 is a rear, bottom, left alternate view of the cask of FIG. 10;

FIG. 12 is a left-side, perspective view of FIG. 9;

FIG. 13 is a front, sectional view of FIG. 12;

FIG. 14 is a right-side perspective view of FIG. 13;

FIG. 15 is a left-side perspective view of FIG. 14;

FIG. 16 is a left-side perspective view of FIG. 15;

FIG. 17 is an exploded view of an inner top base board and an inner fastener receiver block of the invention of FIG. 16;

FIG. 18 is a top, front, left perspective view of the reversible lid;

FIG. 19 is a bottom, rear, right perspective view of FIG. 18;

FIG. 20 is a right-side, sectional view of FIG. 19;

FIG. 21 is a right-side, alternate view of FIG. 20;

FIG. 22 is a top, left perspective view of a plurality of casks of FIG. 21;

FIG. 23 is a top, left alternate view of a plurality of casks of FIG. 23;

FIG. 24 is top, left perspective view of the cask of FIG. 23;

FIG. 25 is a top perspective view of FIG. 24;

FIG. 26 is a top, left alternate view of FIG. 25; and

FIG. 27 is a front sectional view of FIG. 26.

### DETAILED DESCRIPTION OF THE EMBODIMENT(S)

In an embodiment, the teachings herein described a cask lid 10 and a cask assembly system 30 that allows for the construction of a cask 1.

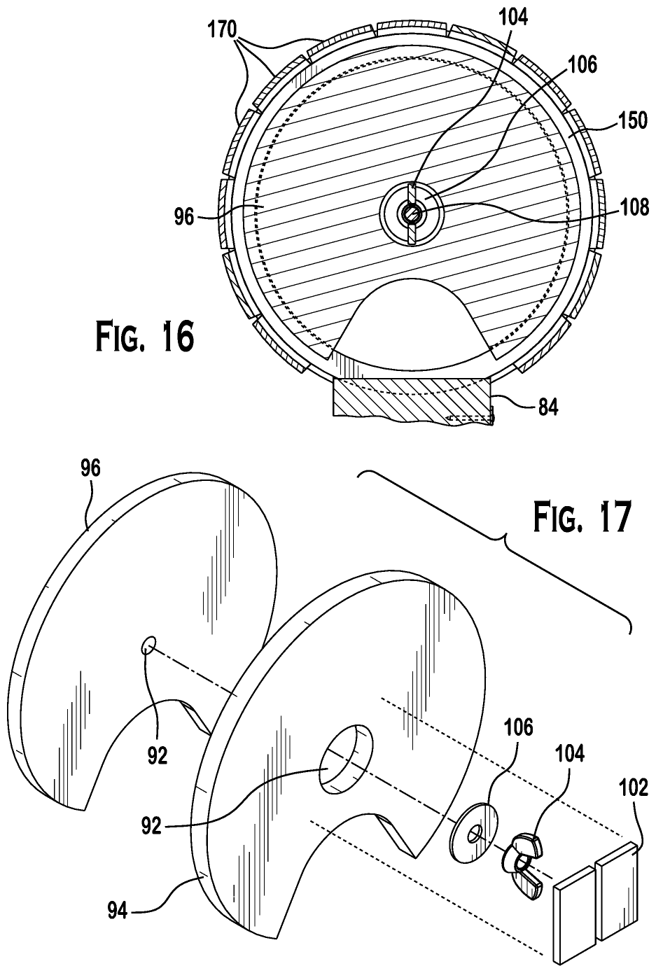

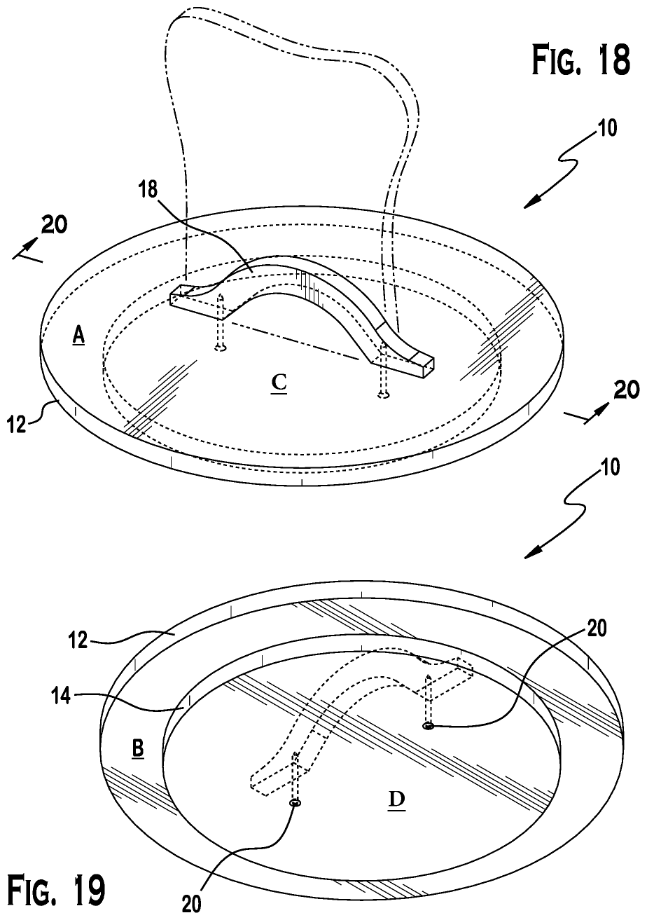

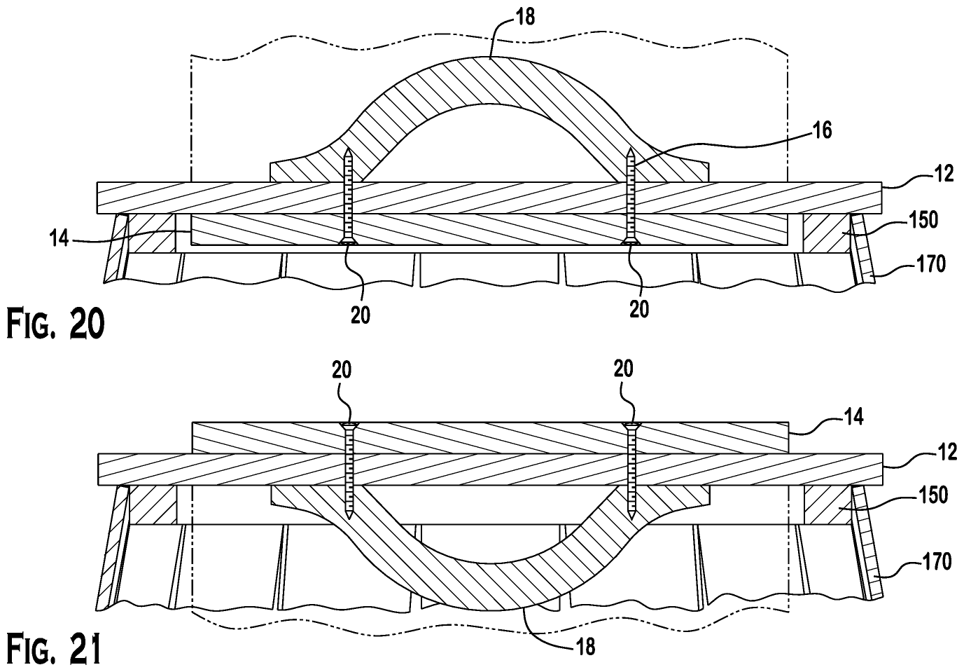

In the exemplary embodiment, the lid 10 generally includes the following major components: a first cask lid plate 12 and a second cask lid plate 14. One of ordinary skill in the art would understand the applicant's design is not the exclusive embodiment. In the exemplary embodiment, the first cask lid plate 12 is a circular member. One of ordinary skill in the art would understand the applicant's design is not the exclusive embodiment. In the exemplary embodiment, the first cask lid plate 12 may include measurements of 12.5 inches sq.×0.5 inches thick. One of ordinary skill in the art would understand the applicant's design is not the exclusive embodiment. In the exemplary embodiment, the first cask lid plate 12 further includes a first face A and a second face B as shown in FIGS. 18 and 19. One of ordinary skill in the art would understand the applicant's design is not the exclusive embodiment. In the exemplary embodiment, the first cask lid plate 12 further includes a plurality of first cask lid plate fastener receivers 16. One of ordinary skill in the art would understand the applicant's design is not the exclusive embodiment. In the exemplary embodiment, the first cask lid plate 12 further includes a handle 18. In the exemplary embodiment the handle 18 is a curvature member. One of ordinary skill in the art would understand the applicant's design is not the exclusive embodiment.

In the exemplary embodiment, the second cask lid plate 14 is a circular member. One of ordinary skill in the art would understand the applicant's design is not the exclusive embodiment. In the exemplary embodiment, the second cask lid plate 14 may include measurements of 9.5 inches×0.5 inches thick. One of ordinary skill in the art would understand the applicant's design is not the exclusive embodiment. In the exemplary embodiment, the second cask lid plate 14 further includes a first face C and second face D as shown in FIGS. 18 and 19. One of ordinary skill in the art would understand the applicant's design is not the exclusive embodiment. In the exemplary embodiment, the first face C of the second cask lid plate 14 is in constant contact with the second face B of the first cask lid plate 12 as shown in FIGS. 18-19. In the exemplary embodiment, the second cask lid plate 14 further includes a plurality of second cask lid plate fastener receivers 20.

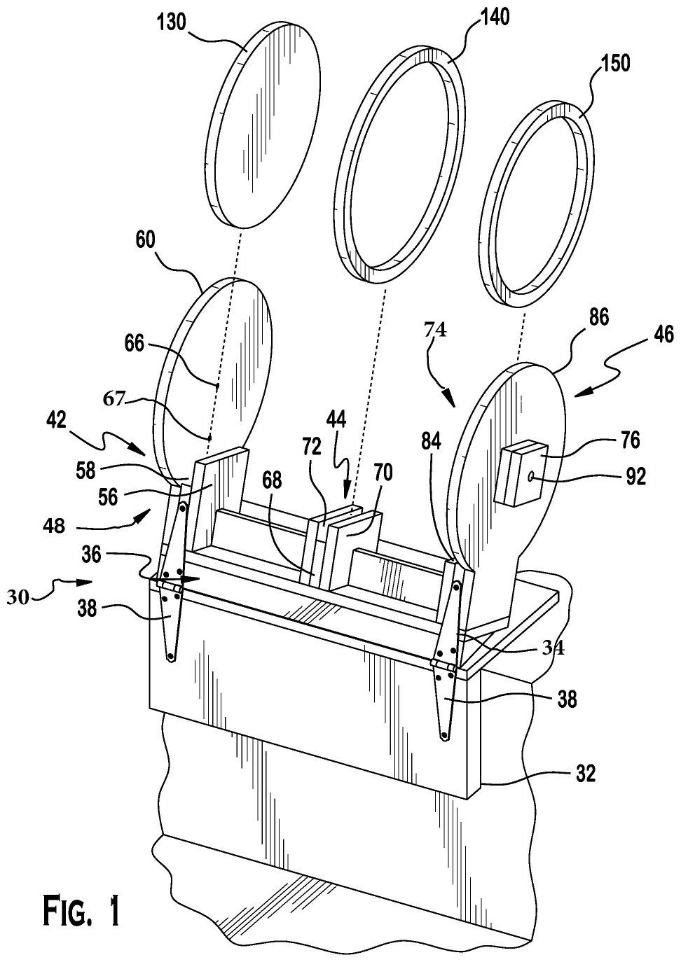

In the exemplary embodiment, the cask assembly system 30 is generally constructed with the following major components: a mount base 32, a pivot device 34, and an insertion board 36 as shown in FIG. 1. One of ordinary skill in the art would understand the applicant's design is not the exclusive embodiment.

In the exemplary the mount base 32 is an elongated L-shaped member. One of ordinary skill in the art would understand the applicant's design is not the exclusive embodiment. In the exemplary embodiment, the mount base 32 is positioned on a level surface. One of ordinary skill in the art would understand the applicant's design is not the exclusive embodiment.

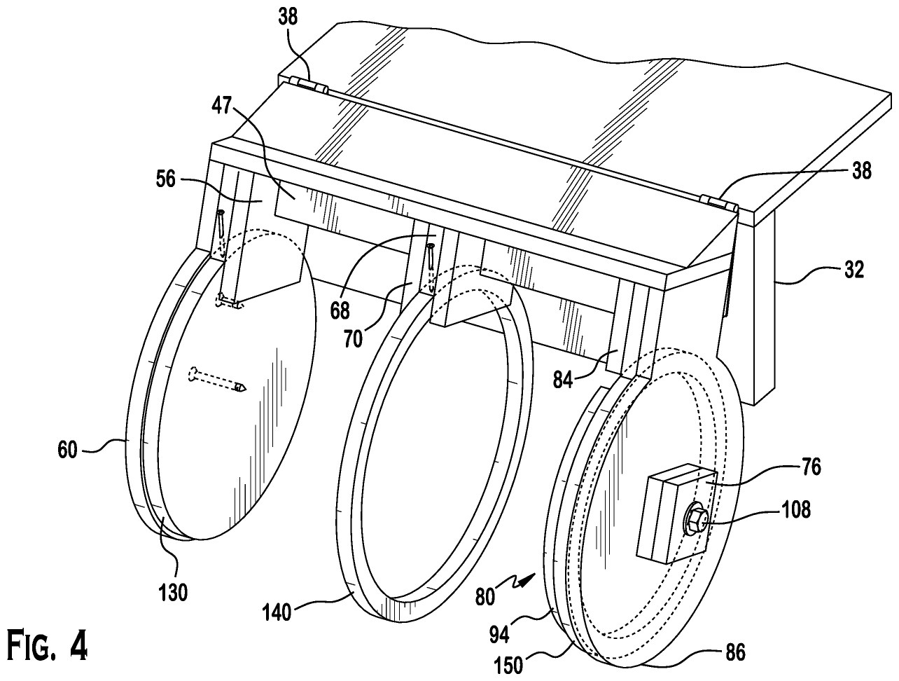

In the exemplary embodiment, the pivot device 34 is a hinge member. One of ordinary skill in the art would understand the applicant's design is not the exclusive embodiment. In the exemplary embodiment, the pivot device 34 further includes a set of plate members 38. In the exemplary embodiment, the set of plate members 38 are triangular-shaped as shown in FIG. 1. One of ordinary skill in the art would understand the applicant's design is not the exclusive embodiment. In the exemplary embodiment, the set of plate members 38 include a plurality of fastener receivers 40 as shown in FIG. 5. In the exemplary embodiment, the plurality of fastener receivers 40 are threaded. One of ordinary skill in the art would understand the applicant's design is not the exclusive embodiment.

In the exemplary embodiment, the insertion board 36 is an elongated rectangular member. One of ordinary skill in the art would understand the applicant's design is not the exclusive embodiment. In the exemplary embodiment, the insertion board 36 is generally constructed with the following components: a base insertion piece 42, a middle hoop insertion piece 44, an upper hoop insertion piece 46 and a linking member 47.

In the exemplary embodiment, the base insertion piece 42 generally includes the following components: a base securing block 48, and a back fastener block 50.

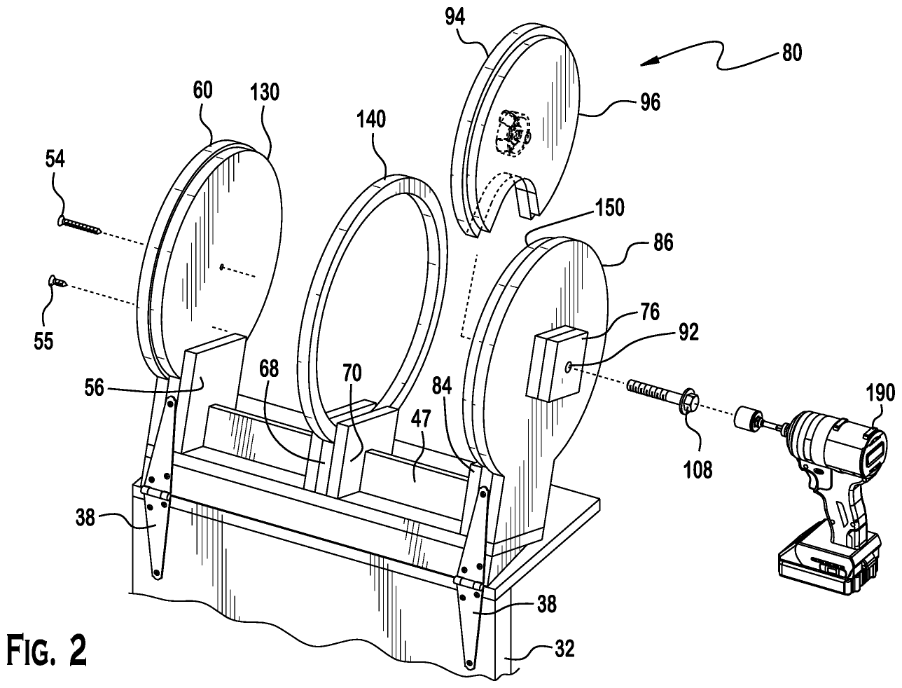

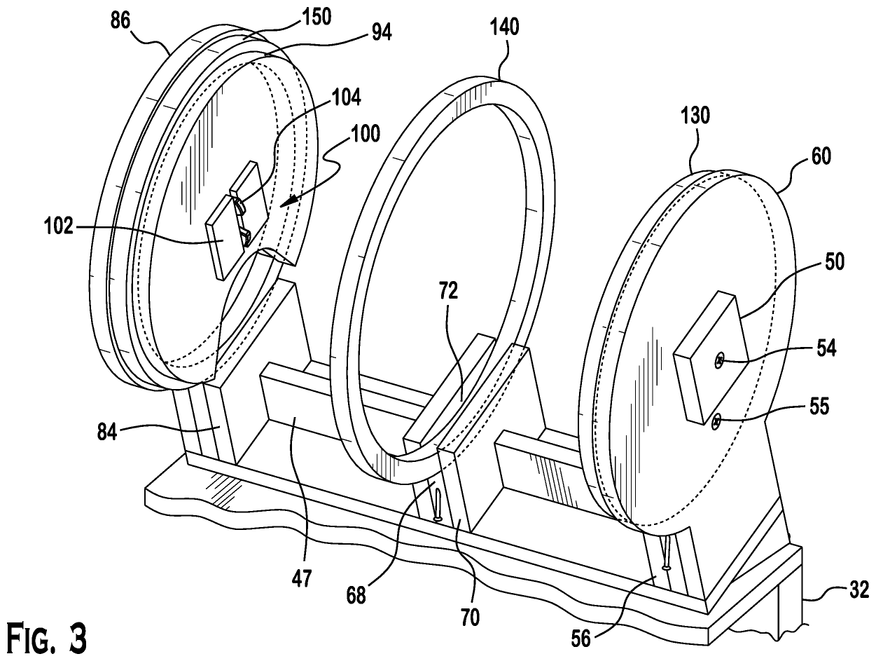

In the exemplary embodiment, the base securing block 48 includes the following components: a holding member 56, a base insert 58 and a base board 60 as shown in FIG. 1. One of ordinary skill in the art would understand the applicant's design is not the exclusive embodiment. In the exemplary embodiment, the holding member 56 is an elongated rectangle. One of ordinary skill in the art would understand the applicant's design is not the exclusive embodiment. In the exemplary embodiment, the base insert 58 is a resting area for a bottom disk 130 of a cask 1 as shown in FIGS. 1-2.

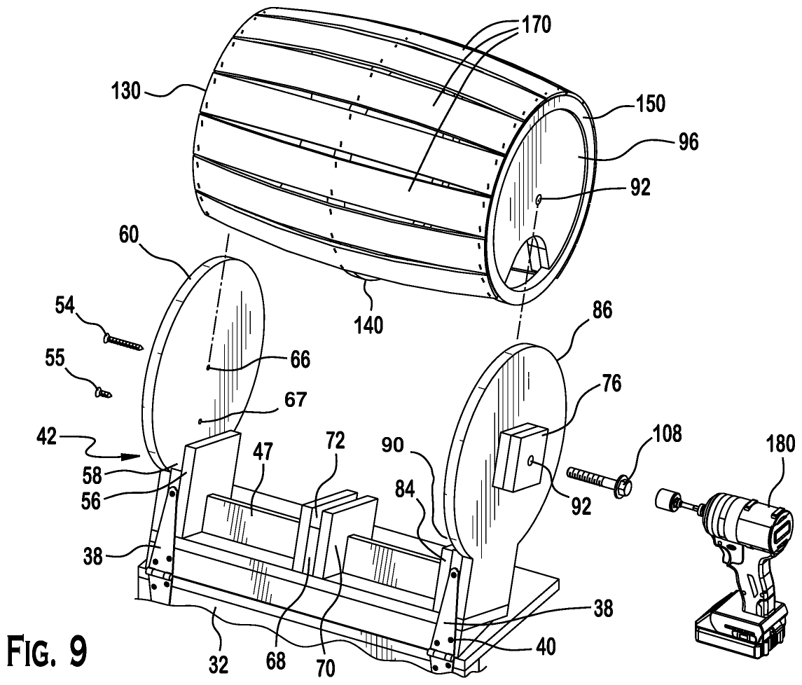

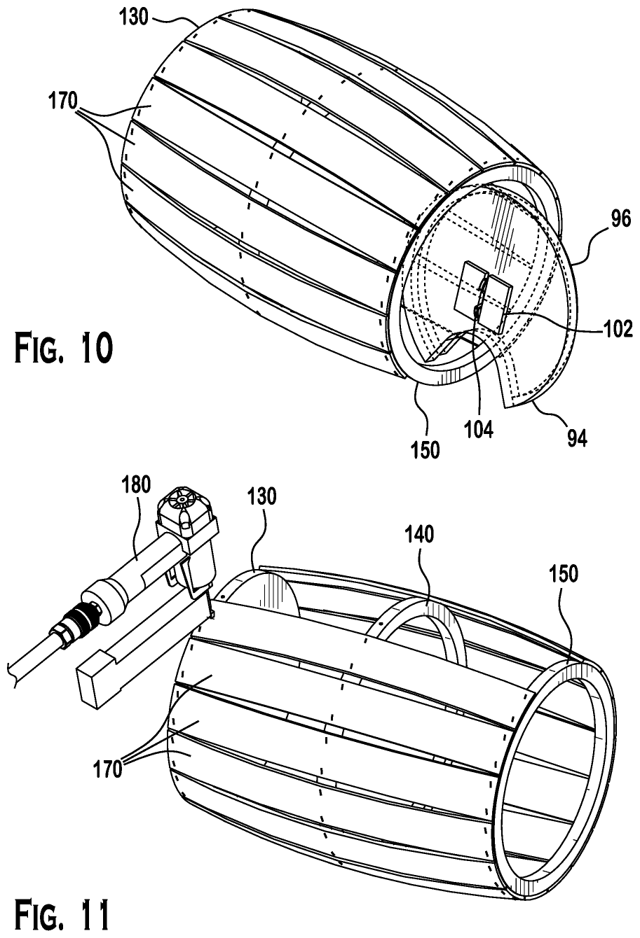

In the exemplary embodiment, the base board 60 is a bulb shaped member. One of ordinary skill in the art would understand the applicant's design is not the exclusive embodiment. In the exemplary embodiment, the base board 60 further includes an elongated fastener receiver 66 located in the central region of the base board 60 as shown in FIG. 9. One of ordinary skill in the art would understand the applicant's design is not the exclusive embodiment. In the exemplary embodiment, the base board 60 further includes an outer fastener receiver 67 as shown in FIG. 9. One of ordinary skill in the art would understand the applicant's design is not the exclusive embodiment. In the exemplary embodiment, the base board 60 further includes a back fastener block 50. The back fastener block 50 is a square member. One of ordinary skill in the art would understand the applicant's design is not the exclusive embodiment.

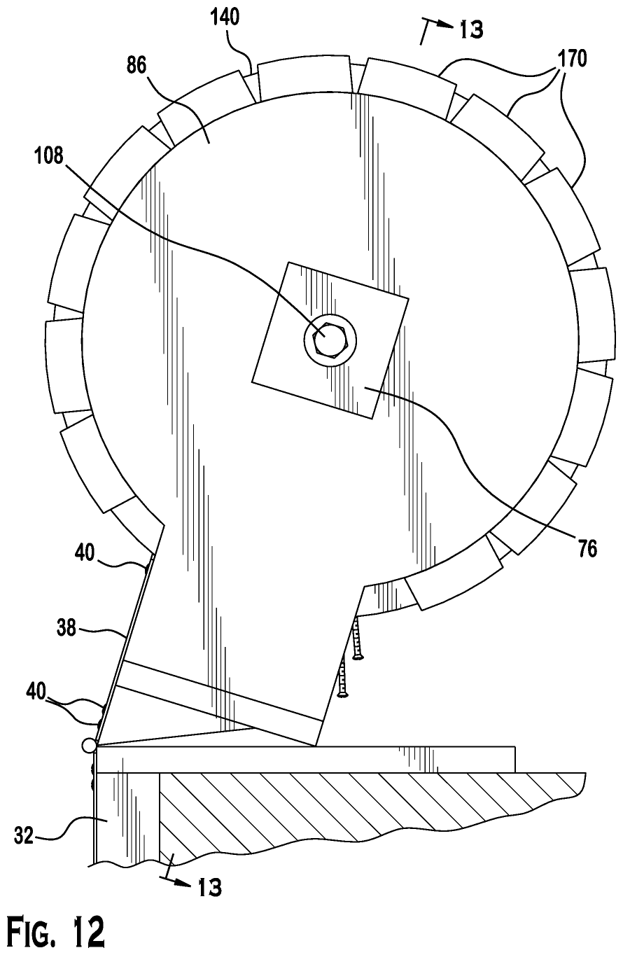

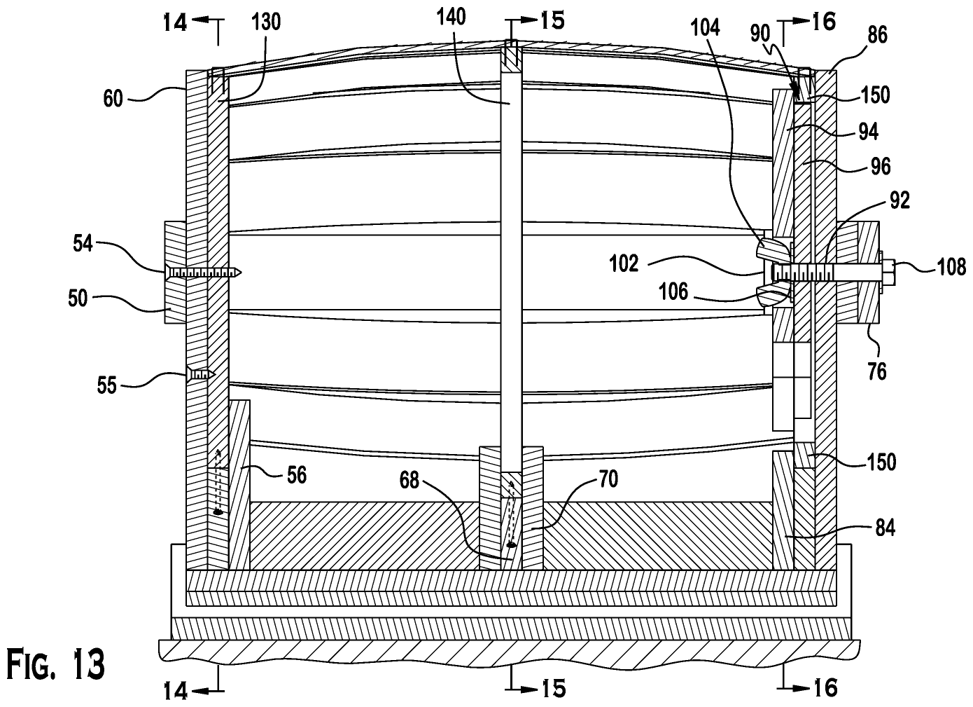

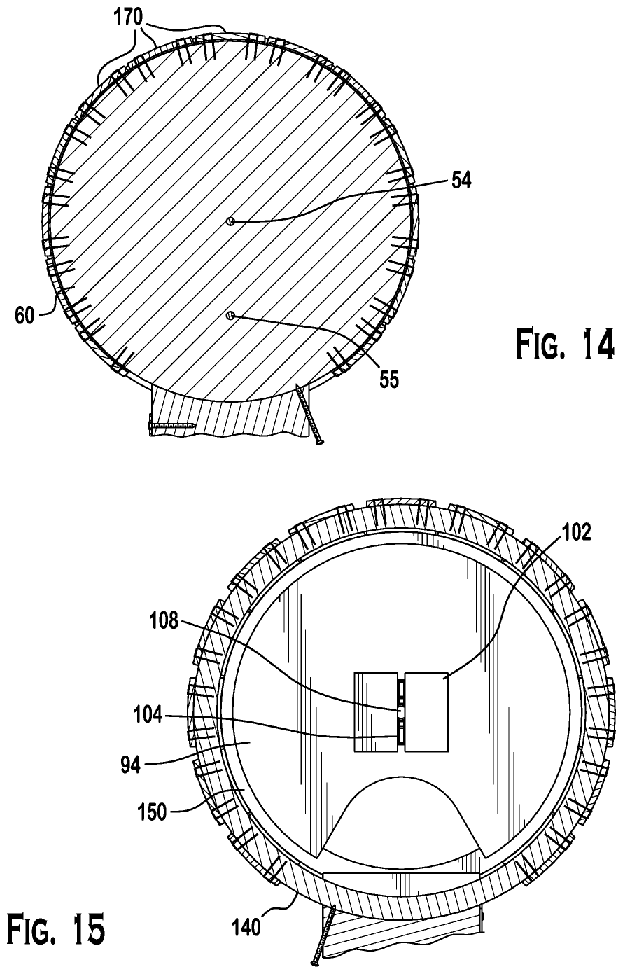

In the exemplary embodiment, the back fastener block 50 and the base board 60 share the elongated fastener receiver 66 which runs therethrough. One of ordinary skill in the art would understand the applicant's design is not the exclusive embodiment. In the exemplary embodiment, the base board 60 further includes an elongated fastener 54. The elongated fastener 54 is a standard fastener. One of ordinary skill in the art would understand the concept of a fastener. In the exemplary embodiment, the base board 60 further includes an outer fastener 55 as shown in FIG. 13. One of ordinary skill in the art would understand the applicant's design is not the exclusive embodiment.

In the exemplary embodiment, the middle hoop insertion piece 44 generally includes the following major components a middle insertion base 68 and a set of side members 70 as shown in FIG. 3. One of ordinary skill in the art would understand the applicant's design is not the exclusive embodiment. In the exemplary embodiment, the middle insertion base 68 is an elongated rectangular member. One of ordinary skill in the art would understand the applicant's design is not the exclusive embodiment. In the exemplary embodiment, the set of side members 70 are elongated plate like members. One of ordinary skill in the art would understand the applicant's design is not the exclusive embodiment.

In the exemplary embodiment, the middle insertion base 68 and the set of side members 70 form a middle insert 72 as shown in FIG. 3. One of ordinary skill in the art would understand the applicant's design is not the exclusive embodiment.

In the exemplary embodiment, the upper hoop insertion piece 46, is generally constructed with the following components: an upper securing block 74, a top support block 76, an inner top board 80 and an inner fastener receiver block 100. One of ordinary skill in the art would understand the applicant's design is not the exclusive embodiment.

In the exemplary embodiment, the upper securing block 74 is generally constructed with the following components: an upper holding support member 84, and an outer top board 86 as shown in FIG. 1. In the exemplary embodiment, the upper holding support member 84 is a plate like member fixed to the insertion board 36 as shown in FIG. 1. One of ordinary skill in the art would understand the applicant's design is not the exclusive embodiment. In the exemplary embodiment, the outer top board 86 is a bulb shaped member. One of ordinary skill in the art would understand the applicant's design is not the exclusive embodiment. In the exemplary embodiment, the upper holding support member 84 and the outer top board 86 form a top insert 90 which is adjacent to the outer top board 86. One of ordinary skill in the art would understand the applicant's design is not the exclusive embodiment.

In the exemplary embodiment, the top support block 76 is square block member. One of ordinary skill in the art would understand the applicant's design is not the exclusive embodiment. In the exemplary embodiment, the top support block 76 further includes the top fastener receiver 92, which is shared with the outer top board 86. One of ordinary skill in the art would understand the applicant's design is not the exclusive embodiment.

In the exemplary embodiment, the inner top board 80 is a circular member with curvature cut-out. One of ordinary skill in the art would understand the applicant design is not the exclusive embodiment. In the exemplary embodiment, the inner top board 80 further includes a first layer 94 and a second layer 96 as shown in FIG. 17. One of ordinary skill in the art would understand the applicant's design is not the exclusive embodiment.

In the exemplary embodiment, the first layer 94 is plate like member that includes a greater circumference than the second layer 96. One of ordinary skill in the art would understand the applicant's design is not the exclusive embodiment. Similarly, in the exemplary embodiment, the second layer 96 is a plate like member and includes a smaller circumference than the first layer 94. One of ordinary skill in the art would understand the applicant's design is not the exclusive embodiment. In the exemplary embodiment, the inner top board 80 further includes the top fastener receiver 92 which is shared with the top support block 76, and the outer top board 86. One of ordinary skill in the art would understand the applicant's deign is not the exclusive embodiment.

In the exemplary embodiment, the inner fastener receiver block 100 is generally constructed with the following components: a dual set of stabilizer blocks 102, a fastener stabilizer 104, a washer 106 and a securing top fastener 108. One of ordinary skill in the art would understand the applicant's design is not the exclusive embodiment. In the exemplary embodiment, the dual set of stabilizer blocks 102 are plate like elongated rectangular members located in the central region of the first layer 94. One of ordinary skill in the art would understand the applicant's design is not the exclusive embodiment. Further, the fastener stabilizer 104 is a receiver located between the dual set of stabilizer blocks 102 as shown in FIG. 17. One of ordinary skill in the art would understand the applicant's design is not the exclusive embodiment. In the exemplary embodiment, the washer 106 is a circular member with a passageway as shown in FIG. 17. One of ordinary skill in the art would understand the applicant's design is not the exclusive embodiment. In the exemplary embodiment, the securing fastener top 108 is a standard fastener. One of ordinary skill in the would understand the ordinary workings of the securing top fastener 108 and the applicant's design is not the exclusive embodiment.

In the exemplary embodiment, the linking member 47 is a two-piece elongated rectangular member which connects the base insertion piece 42, the middle hoop insertion piece 44, and the upper hoop insertion piece 46. One of ordinary skill in the art would understand the applicant's design is not the exclusive embodiment.

In the exemplary embodiment, the cask assembly system 30 is generally constructed with the following major components: a mount base 32, a pivot device 34, and an insertion board 36.

In the exemplary embodiment, the mount base 32 is placed on the edge of a shelf or a level surface as shown through a plurality of the Figures. One of ordinary skill in the art would understand the applicant's design is not the exclusive embodiment. In the exemplary embodiment, the insertion board 36 is fastened to one of the plate members 38 of the pivot device 34 as shown in FIG. 1. One of ordinary skill in the art would understand the applicant's design is not the exclusive embodiment. In the exemplary embodiment, the other plate member 38 is fastened to one of the legs of the mount base 32 as shown in FIG. 2. One of ordinary skill in the art would understand the applicant's design is not the exclusive embodiment.

In the exemplary embodiment, the holding member 56 and the base board 60 of the base securing block 48 are attached to the lower region of the insertion board 36. One of ordinary skill in the art would understand the applicant's design is not the exclusive embodiment. In the exemplary embodiment, the middle insertion base 68 and the set of side members 70 of the middle hoop insertion piece 44 are attached to the central region of insertion board 36 as shown in FIG. 1. One of ordinary skill in the art would understand the applicant's design is not the exclusive embodiment. In the exemplary embodiment, the upper holding support member 84, and the outer top board 86 of the upper securing block 74 are attached to the upper region of the insertion board 36. One of ordinary skill in the art would understand the applicant's design is not the exclusive embodiment.

In the exemplary embodiment, a bottom disk 130 of the cask 1 is inserted into the base insert 58 of the base securing block 48. One of ordinary skill in the art would understand the applicant's design is not the exclusive embodiment. The bottom disk 130 of the cask 1 may include a measurement of 11.5 inches sq.×⅝ inches thick. One of ordinary skill in the art would understand the applicant's design is not the exclusive embodiment. In the exemplary embodiment, the elongated fastener 54 is inserted through the elongated fastener receiver 66 of the base board 60 as an incision is made in the bottom disk 130 of the cask 1 as shown in FIG. 13. One of ordinary skill in the art would understand the applicant's design is not the exclusive embodiment. In the exemplary embodiment the outer fastener 55 is inserted through the outer fastener receiver 67 of the base board 60 and a second incision is made into the bottom disk 130. One of ordinary skill in the art would understand the applicant's design is not the exclusive embodiment.

In the exemplary embodiment, a center ring 140 of the cask 1 is inserted into the middle insert 72 of the middle hoop insertion piece 44. One of ordinary skill in the art would understand the applicant's design is not the exclusive embodiment. In the exemplary embodiment, the center ring 140 may include a measurement of 13.25 inches sq.×⅝ inches thick. One of ordinary skill in the art would understand the applicant's design is not the exclusive embodiment. In the exemplary embodiment, a top ring 150 of the cask 1 is inserted into the top insert 90 located between the inner top board 80 and outer top board 86 of the upper hoop insertion piece 46. One of ordinary skill in the art would understand the applicant's design is not the exclusive embodiment. In the exemplary embodiment, the top ring 150 may include a measurement of 11.5 inches sq.×⅝ inches thick. One of ordinary skill in the art would understand the applicant's design is not the exclusive embodiment. In the exemplary embodiment, the inner top board 80 is fitted to a rear of the top ring 150 in which the first layer 96 is flush against the top ring 150. The top support block 76 is placed over the top fastener receiver 92. The top fastener 108 is threaded through the top fastener receiver 92, the washer 106 and the fastener stabilizer 104 of the inner fastener receiver block 100. One of ordinary skill in the art would understand the applicant's design is not the exclusive embodiment.

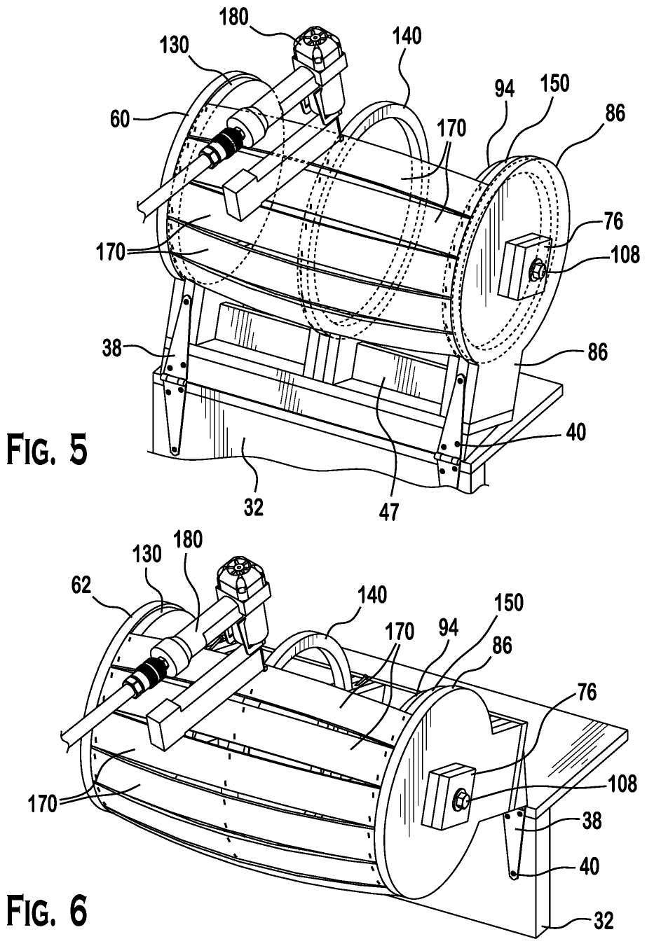

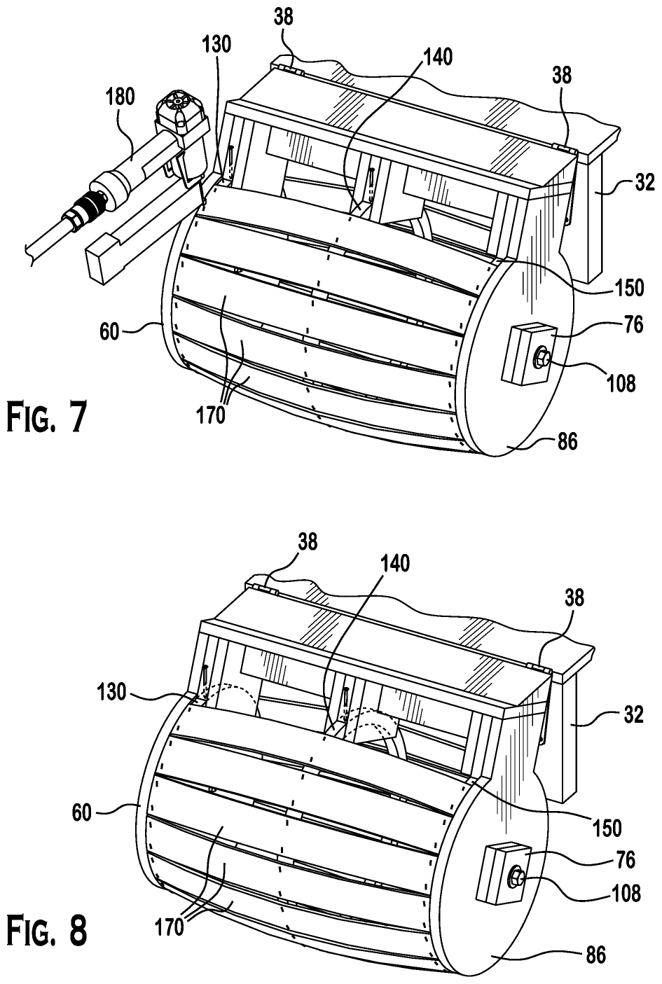

As shown in FIGS. 5-8, a plurality of staves 170 are placed along a length of the cask 1 and are fixed to the bottom disk 130, the center ring 140 and the top ring 150 of the cask 1 by a trigger tacker 180. As the user, fixes the staves 170 around the cask 1, the user may rotate the cask 1 by the pivot device 34. Prior to the completion of the cask, the user has the ability to use a loosening device 190 to loosen the fastener 108, the elongated fastener 54 and the outer fastener 55 that is securing the cask 1 to the cask assembly system 30, and remove the cask 1.

The user then exerts force onto the inner top board 80 and removes the inner top board 80 by pulling the inner top board 80 through the remaining opening in a central region of the cask 1 where the last few staves 170 will be fixed prior to completion as shown in FIGS. 10 and 11. The last few staves 170 are then fixed to the cask 1. The total length of the cask 1 may measure 18 inches. One of ordinary skill in the art would understand the applicant's design is not the exclusive embodiment.

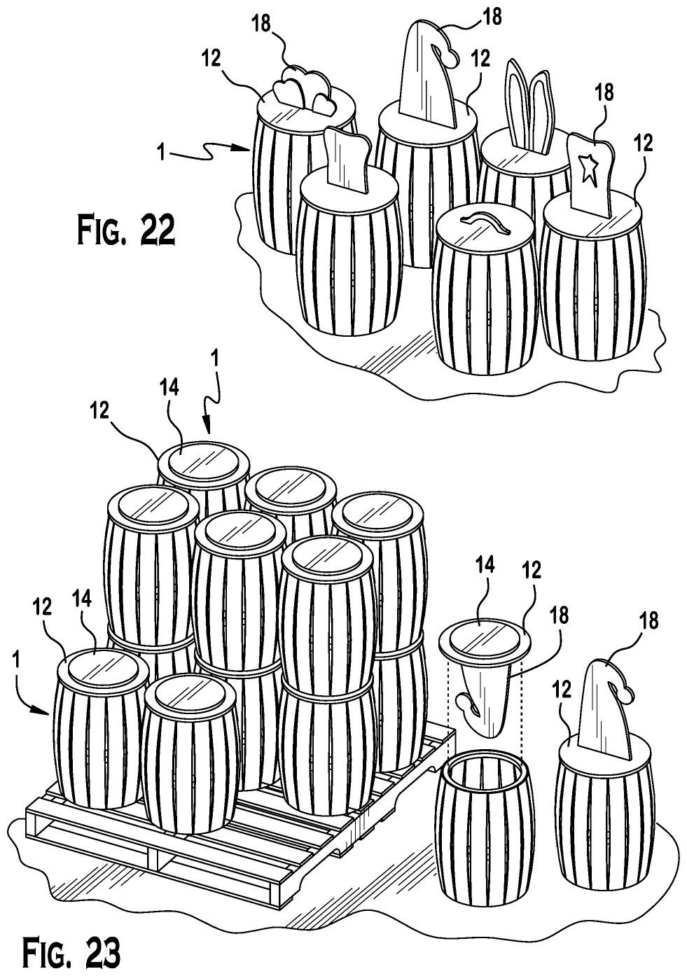

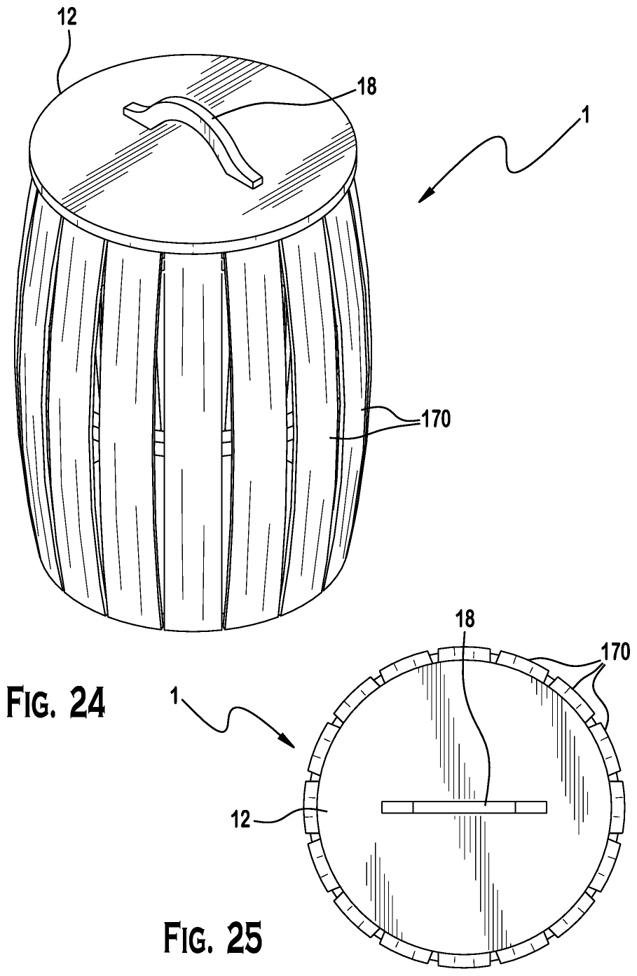

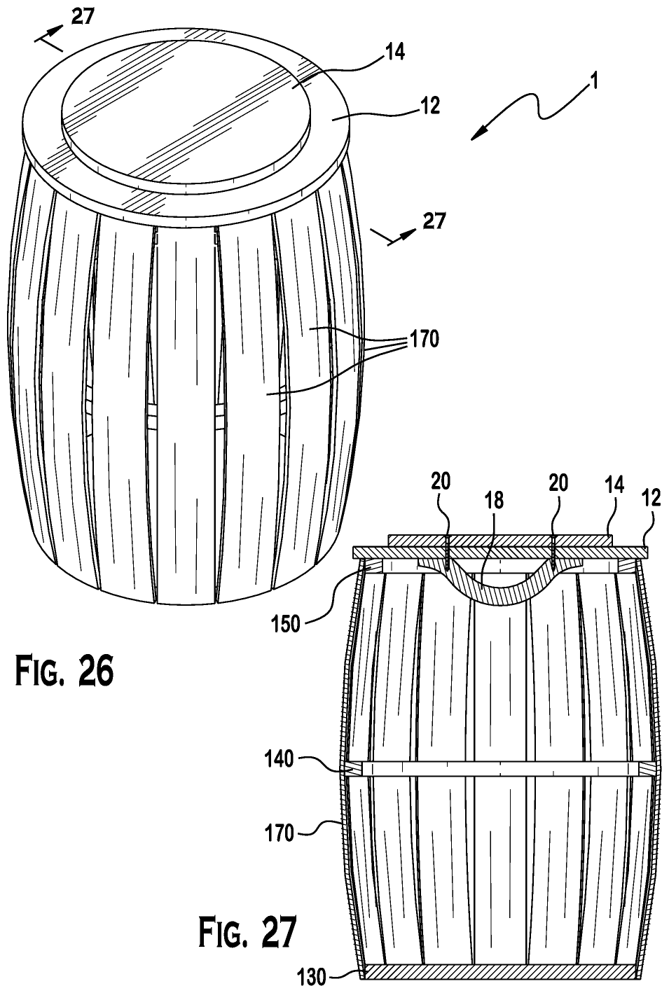

The lid 10 is then placed on an open end of the cask 1. If there is a handle 18, or a protruding object on the first cask lid plate 12, the user is able to flip the lid 10 to the second cask lid plate 14 in order for multiple casks 1 to be stacked on top of each other by placing the bottom disk 130 of the first cask 1 on top of the second cask lid plate 14 of the lid 10 of the second cask as shown in FIGS. 22-27.

The foregoing illustrates some of the possibilities for practicing the invention. Many other embodiments are possible within the scope and spirit of the invention. It is, therefore, intended that the foregoing description be regarded as illustrative rather than limiting, and that the scope of invention is given by the appended claims together with their full range of equivalents.

What is claimed is:

1. A cask comprising:
a body having:
a top ring;
a bottom disk;
a center ring positioned equidistance between the top ring and the bottom disk;
a plurality of staves positioned around an outer edge of the bottom disk, an outer edge of the center ring and an outer edge of the top ring, the plurality of staves positioned apart from each and connecting the top ring, the bottom disk and the center ring; and
a reversible lid with a first cask lid plate with a handle positioned on a top surface thereof and a second cask lid plate positioned on an opposite surface thereof and providing a means for supporting a stacking of a plurality of casks.

2. The cask assembly of claim 1, wherein a length of the cask is 18″.

3. The cask assembly of claim 2, wherein the top ring of the cask includes a measurement of 11.25″ sq×⅝″ thick.

4. The cask assembly of claim 3, wherein the center ring of the cask includes a measurement of 13.25″ sq×⅝″ thick.

5. The cask assembly of claim 4, wherein the bottom of the cask includes a measurement of 11.25″ sq.×⅝″ thick.

6. The cask assembly of claim 5, wherein the first cask lid plate includes a measurement of 12.5″×0.5″ thick.

7. The cask assembly of claim 6, wherein the second cask lid plate includes a measurement of 9.5″×0.5″ thick.

8. A cask assembly system for constructing a cask comprising:
a mount base positioned on a top of a level surface and having a first leg and a second leg;
a pivot device fastened to the first leg;
an insertion board placed on top of the second leg fastened to the pivot device for rotation of a cask while in production, the insertion board having:
a base insertion piece mounted at a first end of the insertion board;
an upper hoop insertion piece mounted at a second end of the insertion board; and
a middle hoop insertion piece mounted between the base insertion piece and the upper hoop insertion piece.

9. The cask assembly system of claim 8, wherein the base insertion piece further includes a base securing block, and a back fastener block.

10. The cask assembly system of claim 9, wherein the base securing block further includes a holding member, and a base board.

11. The cask assembly system of claim 10, wherein the middle insertion piece further includes a middle insertion base and a set of side members wherein the components form a middle insert.

12. The cask assembly system of claim 11, wherein the upper hoop insertion piece further includes an upper securing block, a top support block, an inner top base board and an inner fastener receiver block.

13. The cask assembly system of claim 12, wherein the upper securing block further includes an upper holding support member and an outer top board.

14. A method for constructing a cask comprising:
a bottom disk of the cask is inserted into a base insert of a base securing block, an elongated fastener is inserted through an elongated fastener receiver of a base board and an incision is made in the bottom disk of the cask;
a center ring of the cask is inserted into a middle insert of a middle hoop insertion piece;
a top ring of the cask is inserted into a top insert located between an inner top board and an outer top board of an upper hoop insertion piece, the inner top board is fitted to a rear of the top ring, a top support block is placed over a top fastener receiver wherein a top fastener is threaded through the top fastener receiver, a washer and a fastener stabilizer of an inner fastener receiver block;
a plurality of staves are placed along a length of the cask and are fixed to the bottom disk, the center ring and the top ring of the cask, the cask is rotatable by a pivot device, a fastener of an upper holding support member and the elongated fastener of the base insertion piece are loosened for removal of the cask, an inner top board is removed through a remaining opening in a central region of the cask; and the remaining opening is covered with at least one of the plurality of staves.

15. The method for constructing the cask of claim 14, wherein a lid is then placed on an open end of the cask.

16. The method for constructing the cask of claim 15, wherein the bottom disk of the cask includes a measurement of 11.5 inches sq.×⅝ inches thick.

17. The method for constructing the cask of claim 16, wherein the center ring of the cask includes a measurement of 13.25 inches sq.×⅝ inches thick.

18. The method for constructing the cask of claim 17, wherein the top ring of the cask includes a measurement of 11.5 inches sq.×⅝ inches thick.

19. The method for constructing the cask of claim 18, wherein the cask includes a length of 18 inches.

20. The method for constructing a cask of claim 19, wherein the lid is reversible for stack-ability of the cask.
